(19) United States
(12) Patent Application Publication
(10) Pub. No.: US 2025/0289498 A1
(43) Pub. Date: Sep. 18, 2025

(54) RECREATIONAL VEHICLE, RECREATIONAL TRAILER, ASSEMBLY FOR SPECIFIYING PARKING AREAS FOR RECREATIONAL TRAILERS, AND SYSTEM AND METHOD FOR A RECREATIONAL TRAILER

(71) Applicant: ERWIN HYMER GROUP SE, Bad Waldsee (DE)

(72) Inventors: Emre AYDIN, Bad Waldsee (DE); Georg SINGER, Obermarchtal (DE); Rüdiger FREIMANN, Eberhardzell (DE)

(21) Appl. No.: 18/862,356

(22) PCT Filed: May 2, 2023
(86) PCT No.: PCT/EP2023/061575

§ 371 Date: Nov. 1, 2024

(30) Foreign Application Priority Data
May 1, 2022 (DE) 10 2022 110 612.8

(51) Int. Cl. B62D 15/02; B62D 13/06

(52) U.S. Cl. CPC B62D 15/0285; B62D 13/06

(57) ABSTRACT

The invention relates to a recreational vehicle, in particular a recreational trailer, in particular a mobile home or a trailer comprising a living space which can be produced in the parked state. The recreational vehicle comprises a chassis and a structure which is connected to the chassis. Furthermore, electrically driven wheels are arranged on the chassis, and surroundings detection sensors are additionally provided which detect the surroundings of the structure and/or the chassis during a parking operation and/or an operation for exiting the parking area. In order to detect at least one position signal coming from an external position transmission element during the parking operation and/or the operation for exiting the parking area, detection devices are provided. Additionally, a controller is provided which is designed to at least indirectly actuate the at least one wheel during the parking operation and/or the operation for exiting the parking area such that an automatic parking and/or exiting process with respect to the at least one position signal is facilitated, and a collision of the structure and/or the chassis with the surroundings is simultaneously prevented by means of the surroundings detection sensors. The invention additionally relates to an assembly for specifying parking areas, to a system comprising a recreational vehicle, and to a method for parking into and/or exiting parking areas.

Recreational vehicle, recreational trailer, arrangement for specifying parking spaces for recreational trailers and system and method for a recreational trailer.

The invention relates to a recreational vehicle and a recreational trailer, in particular a caravan or a trailer with a living space that can be created when parked. The invention further relates to an arrangement for specifying parking spaces for such a recreational vehicle or a recreational trailer as well as a corresponding system and a method.

From DE 202012010077 U1 a trailer is known which is designed as a caravan. A shunting drive can be provided here, which is an auxiliary drive. The auxiliary drive has a drive unit with an electric motor for each wheel of the trailer. The electric motors are supplied with electrical energy by a battery in the trailer and can be coupled to the trailer's wheels in order to drive them and thus maneuver the trailer.

From DE3223214 A1 a targeting device for a trailer hitch is known. The aiming device consists of a rod placed on the coupling ball of the towing vehicle, the upper end of which is visible to the driver via the inside rearview mirror and the rear window.

From DE10237615 C1 a method and a device for positioning second objects relative to one another are known. Here, a transmitter emits a signal beam at a defined beam angle, which is detected by the receiver unit connected to a computer, so that two longitudinal axes are essentially aligned with one another by moving the objects relative to one another until the same number of receivers are present. Both sides of a central point of the receiver unit detect the signal beam with essentially the same intensity and the two objects are brought closer to each other in a controlled manner via a distance measurement using the transmitter and the receiver unit. From DE102020121899 A1 a system for supporting the alignment of a vehicle for coupling to a trailer is known. Here, image data is received and a location identifier of a coupling ball of the vehicle is applied to the image data and a coupler of the trailer is identified in the image data. Further, steering control signals are output to the steering system when the vehicle is reversing to align the location identifier of the hitch ball in the image data with the coupler of the trailer.

Furthermore, it is known from DE 102021111303 A1 to store and retrieve a GPS location of a trailer for a clutch support process.

In the case of a conventional approach with a vehicle to a trailer, this depends on the driving qualities and skill of the user. This can be very demanding, particularly in narrow, difficult-to-access spaces or on uneven road conditions, and can also be associated with dangerous situations such as unwanted movements or the trailer rolling away. In addition, after long journeys, for example when traveling to a holiday area, the user may be so tired that he is no longer able to park the trailer in a gap that is difficult to access or it is too dangerous for him to do so.

The object of the invention is a leisure vehicle, in particular a leisure trailer, in particular a caravan or a trailer with a living space that can be produced when parked, an arrangement for specifying parking spaces for leisure vehicles and/or leisure trailers, a system with a leisure vehicle and/or a leisure trailer and to specify a method that enables improved design and functionality.

The object is achieved by a leisure vehicle, in particular a leisure trailer, with the features of independent patent claim 1, an arrangement with the features of patent claim 8, a system with the features of patent claim 9 and a method with the features of patent claim 10. Advantageous developments of the invention are specified in the subclaims. The task is achieved by a leisure vehicle, in particular a leisure trailer, in particular a caravan or a trailer with a living space that can be produced in the parked state, with a chassis, a structure connected to the chassis and at least one electrically driven wheel arranged on the chassis, with environmental detection sensors are provided, which detect an environment of the body and/or the chassis in a parking and/or parking operation, at least one detection device for detecting at least one position signal, which emanates from an external position transmitting element in the parking and/or parking operation, is provided and wherein a control is provided which is designed to at least indirectly control the at least one wheel in the parking and/or parking operation in such a way that automatic parking and/or parking with respect to the at least one position signal is possible and at the same time by means of the environment detection sensors a collision of the body and/or the chassis with the surroundings is prevented.

Furthermore, the task is solved by an arrangement for specifying parking spaces for such recreational vehicles and/or such recreational trailers, with a plurality of position transmitting elements being provided which send out position signals that specify the parking spaces for parking and/or parking operations of the recreational vehicles and/or recreational trailers and in order to specify the parking spaces, at least one position transmitting element is arranged at each parking space.

In addition, the task is solved by a system with a recreational vehicle and/or a recreational trailer and at least one external position transmitting element that can be arranged in the vicinity of the body and/or the chassis for parking and/or parking operations.

Furthermore, the object is achieved by a method for parking in and/or out of a parking space, in particular parking in and/or out of a campsite and/or for producing and/or maintaining and/or storing such a recreational vehicle and/or recreational trailer, wherein by means of at least one external position transmitting element, a movement of the recreational vehicle and/or the recreational trailer is carried out by means of the parking and/or parking operation. The external position transmitting elements are not necessarily components of the recreational vehicle according to the invention, in particular the recreational trailer.

For example, external position transmitting elements can also be positioned by an operator of a campsite in order to enable use with the recreational vehicle according to the invention, in particular recreational trailer. The mentioned advantages of a leisure trailer can be realized in a corresponding manner in a leisure vehicle.

Advantageously, automated movement of the leisure trailer can be made possible, so that the user can easily park in narrow gaps or places that are difficult to access. The electric drive of the leisure trailer can be used advantageously. This makes it easy to use, for example on a campsite or for parking in a winter camp. In this case, physical assistance from the user can be completely dispensed with and an independently automated movement can take place to park and/or unpark the leisure trailer.

This makes automated movement of the recreational trailer possible, which, among other things, does not depend on the attention or skill of the user. In particular, a tired user can comfortably park the recreational trailer in a campsite or the like in a gap or the like that is difficult to access.

It is advantageous that the position signal is based on a near-field communication, in particular a Bluetooth-based near-field communication. This enables an advantageous implementation.

It is also advantageous for the control to have a user interface through which a user can intervene, in particular aborting the parking and/or parking operation. In this case, supervision by the user can also be made possible in a given application, which may be required for liability reasons, by campsite regulations or the like.

Furthermore, it is advantageous that the control is designed to determine at the beginning of a parking and/or exit operation whether a collision-free automatic parking and/or parking out is possible in relation to the at least one position signal. This avoids that parking has already begun and then stops to avoid collisions. This means the user can choose a suitable parking space or create suitable circumstances from the outset.

It is advantageous that the control is designed to carry out a coupling process on a towing vehicle, with at least one position signal being detectable by at least one position transmitting element provided on the towing vehicle and with a fine positioning of a coupling element to a coupling element of the towing vehicle taking place by means of a coupling sensor. This results in a particularly comfortable use. The position transmitting element provided on the towing vehicle, the coupling element of the towing vehicle and the towing vehicle itself are not components of the leisure trailer according to the invention. Furthermore, automatic coupling can be realized according to these features. This automatic coupling and the implementations made for automatic coupling can also be used as an independent invention on their own. This is particularly suitable for a leisure trailer with its own drive to extend the range.

It is also advantageous for the clutch sensor to have a reed contact and/or magnetic switch and/or a button. This advantageously makes it possible to implement a target sensor system that identifies or localizes the target with sufficient precision. For example, an accuracy of 1.5 cm may be required for coupling. Depending on the design, the positioning accuracy achieved via the position signals can be greater than this required accuracy. In such a case, the required accuracy can then be achieved using the target sensors. A cross bearing can also be used here.

It is also advantageous that an electric drive and a trailer accumulator are provided for the electric drive, that at least two wheels are driven by the electric drive and that the electric drive, the trailer accumulator and the electrically driven wheels are designed so that when traveling an extension of the range is possible. In particular, a towing vehicle based on an electric drive can be used in this way. The leisure trailer can therefore advantageously have an independent electric drive with a control, an electric machine, a battery and brakes. This electric drive can then be used to automatically move the leisure trailer.

For the automated movement of the leisure trailer, sensors (detectors) are advantageously used that can measure the environment or a distance to surrounding objects. The position transmitting elements can be designed to be very small and stowable so that they can be carried in the leisure trailer. To park and/or exit a parking space, these position transmitting elements can then be placed by a user on the gap or spot to be driven through.

The position transmitting elements can therefore form the reference for moving the leisure trailer to the location to be driven. The leisure trailer can therefore recognize the desired gap. Here it can be decided whether the leisure trailer can actually be moved into the location specified by the position transmitting element. Preferably only then is the automated movement of the recreational trailer initiated. However, this can also be continuously updated during operation, so that a certain level of advance calculation is possible in order to terminate the process early if necessary.

Environment detection sensors can be designed corresponding to parking sensors. The environmental detection sensors and the detection devices can be evaluated together by the controller. This allows the control to calculate and execute further processes or movements in order to move to the desired location or into the desired gap.

After the desired end position has been reached, the position transmitting elements can be stowed back in the leisure trailer. The user can cancel the automated process at any time via a control interface. Furthermore, the automated movement of the leisure trailer can also be used advantageously in other application situations. For example, automated movement can also be used for parking and parking in a winter warehouse or storage hall. Furthermore, automated movement can also be used in production, service, maintenance or storage. The leisure trailer can also be used as an aircraft trailer, in particular for sports aircraft, as a boat trailer, as a horse trailer or the like.

The use of automated movement by an operator or in cooperation with an operator of a campsite, a winter camp or the like is particularly advantageous. Permanently installed external position transmitting elements can be used by the operator to mark parking spaces, bays or the like.

If necessary, it is also possible to use the environmental detection sensors for other purposes, for example to prevent a collision with objects while driving, for example when driving through an open gate or past other vehicles.

Depending on the design, one or more of the following advantages can thus be realized. The movement of the leisure trailer can be automated and therefore independent of the user's skill. If necessary, the leisure trailer can be retracted more quickly without any additional effort on the part of the user. If necessary, the recreational trailer can independently determine whether the gap to be driven through is suitable. In addition, the risk of injury from people nearby or the user themselves can be reduced. In addition, the probability or possibility of the recreational trailer hitting or driving into obstacles can be reduced. Furthermore, automation of the production and/or storage process can be supported during production of the leisure trailer. In addition, an operator of a campsite, a parking space or the like can determine exactly how the recreational trailers should be positioned. An application for different types of trailers can also be implemented. The components can be retrofitted or integrated into the leisure trailer during production. Further advantages and details of the invention are explained in more detail using the exemplary embodiments shown in the schematic figure. This shows:

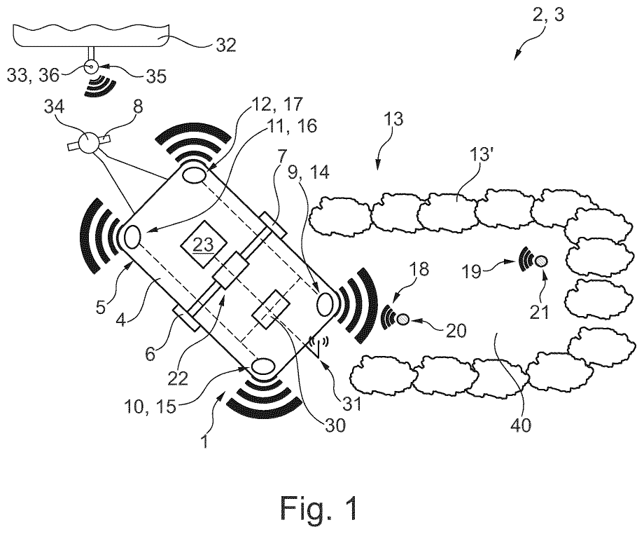

FIG. 1 shows a leisure trailer in a schematic representation to explain possible exemplary embodiments of the invention, a view from above of the leisure trailer, a towing vehicle shown in part and an environment shown in part.

FIG. 1 shows a leisure trailer 1 in a schematic representation to explain possible exemplary embodiments of the invention. The leisure trailer 1 can in particular be designed as a caravan or as a trailer with a living space that can be created when parked. For example, a folding roof can be accommodated in the trailer. Furthermore, the invention is suitable not only for leisure trailers 1, but also generally for leisure vehicles 1. An arrangement 2 with the leisure trailer 1 is also shown. A system 3 with the leisure trailer 1 is also explained in more detail here. Furthermore, a method that can be carried out with the leisure trailer 1 is explained.

The leisure trailer 1 has a chassis 4 and a structure 5. The structure 5 is directly or indirectly connected to the chassis 4. Furthermore, wheels 6, 7, 8 are provided in this exemplary embodiment. which are electrically driven.

The leisure trailer 1 has environmental detection sensors 9 to 12, which can be attached to the chassis 4 or the body 5, for example. The environmental detection sensors 9 to 12 can be activated temporarily depending on the application. In particular, the environment detection sensors 9 to 12 are activated for parking and/or parking operations, with the environment 13 of the body 5 or the chassis 4 being detected. In this exemplary embodiment, objects 13′, for example bushes 13′, are provided in the surrounding area, which represent obstacles and should not be hit or driven over. An object 13′ is marked as an example.

In addition, detection devices 14 to 17 are attached to the leisure trailer 1, which serve to detect position signals 18, 19, which from external position transmitting elements 20, 21 are broadcast. This occurs in particular during parking and/or parking operations. The external position transmitting elements 20, 21 can be placed on the floor or in another location by a user, for example. In another exemplary embodiment, the external position transmitting elements 20, 21 can also be permanently installed. For example, a campsite operator can permanently mount the position transmitting elements 20, 21 on the campsite.

The leisure trailer 1 has an electric drive 22 and an accumulator (vehicle battery) 23. This preferably results in an extension of the range for the leisure trailer 1. The electric drive 22 is used to drive the wheels 6, 7. Depending on the design, the wheels 6, 7 can be controlled individually, for example to enable cornering. It is also conceivable that the wheel 8 is driven and/or steered.

The leisure trailer 1 has a control 30. The controller 30 is connected to both the environmental detection sensors 9 to 12 and to the detection devices 14 to 17. To simplify the illustration, the detection devices 14 to 17 are housed or shown together with the environmental detection sensors 9 to 12. The controller 30 is also connected to the electric drive 22.

In this exemplary embodiment, the controller 30 controls the wheels 6, 7 for parking and/or parking operation. Here, the direction in which the leisure trailer 1 should park, for example, is recorded via the position signals 18, 19. The environment detection sensors 9 to 12 prevent a collision with the objects 13′ of the environment 13. Parking can thus advantageously take place.

In a preferred embodiment, the position signals 18, 19 are based on near-field communication. A Bluetooth connection in particular can be used. It is also possible to transfer further information. This allows the controller 30 to detect, for example at a campsite with permanently mounted position transmitting elements 20, 21, whether the correct parking space 40 has been selected. If necessary, the controller 30 can then request the user to drive to another parking space. In addition, the controller 30 can enable user intervention. Here, the schematically illustrated user interface 31 is preferably designed so that the user can carry out an intervention at any point at a certain distance from the leisure trailer 1 with a mobile device, in particular a cell phone. For example, an application can be provided on a mobile phone. Specifically, the user can then cancel parking. The user preferably activates the method for parking via his mobile device. This allows the user to be at a certain distance from the recreational trailer 1 when the recreational trailer begins to move, which further reduces the risk of accidents.

The controller 30 then preferably detects the environment 13 at the beginning and determines whether automatic parking of the leisure trailer 1 in the parking space 40 is possible.

Furthermore, an additional or alternative embodiment is possible with regard to a coupling of the leisure trailer 1 to a towing vehicle 32, in particular a car. Here, the controller 30 can carry out the coupling process to the towing vehicle 32 automatically. For this embodiment, a position transmitting element 33 is provided on the towing vehicle 33. As a result, the leisure trailer 1 can be coupled with its coupling element 34 to a coupling element 35 of the towing vehicle 32. The position transmitting element 33 can be provided on the coupling element 35, for example. The controller 30 can then drive the leisure trailer 1 to the towing vehicle 32 in such a way that the coupling element 34 of the leisure trailer 1 reaches the coupling element 35 of the towing vehicle 32.

In addition, a clutch sensor 36 can be provided on the clutch element 35 of the towing vehicle 32. This can be designed, for example, as a reed contact, magnetic switch or button. This allows fine positioning to take place if the accuracy via the position transmitting element 33 is not sufficient.

The invention is not limited to the embodiments described.

1. Leisure vehicle, in particular leisure trailer, in particular caravan or trailer with a living space that can be created when parked, with a chassis, a structure connected to the chassis and at least one on the chassis arranged, electrically driven wheel, characterized in that environmental detection sensors are provided, which detect an environment of the structure and/or when parking and/or leaving a parking space of the chassis detect that at least one detection device is provided for detecting at least one position signal, which emanates from an external position transmitting element during parking and/or parking operation and in that a control is provided which is designed to at least indirectly control the at least one wheel in the parking and/or parking operation in such a way that automatic parking and/or parking with respect to the at least one position signal is made possible and at the same time a collision of the body and/or the chassis with the environment is prevented by means of the environment detection sensors.

2. Recreational vehicle according to claim 1, characterized in that the position signal is based on a near-field communication, in particular a Bluetooth-based near-field communication.

3. Recreational vehicle according to claim 1, characterized in that the control has a user interface via which a user can intervene, in particular abort the parking and/or exit operation.

4. Recreational vehicle according to claim 1, characterized in that the control is designed at the beginning of an on and/or Parking operation to determine whether collision-free automatic parking and/or parking is possible in relation to the at least one position signal.

5. Recreational vehicle according to claim 1, characterized in that the control is designed to carry out a coupling process to a towing vehicle, with at least one position signal from at least one position transmitting element provided on the towing vehicle can be detected and wherein a coupling element is finely positioned on a coupling element of the towing vehicle by means of a coupling sensor.

6. Recreational vehicle according to claim 5, characterized in that the clutch sensor has a reed contact and/or a magnetic switch and/or a button.

7. Recreational vehicle according to claim 1, characterized in that an electric drive and an accumulator, in particular a trailer accumulator, are provided for the electric drive, that at least two wheels are driven by the electric drive and that the electric drive, the accumulator and the electrically driven wheels are designed so that an extension of the range is possible when traveling.

8. Arrangement for specifying parking spaces for recreational vehicles. in particular recreational trailers, which are designed according claim 1, with a plurality of position transmitting elements which are for-and/or parking operations of the recreational vehicles send out position signals which specify the parking spaces, with at least one position transmitting element being arranged at each parking space to specify the parking spaces.

9. System with a recreational vehicle, in particular a recreational trailer, according to claim 1 and at least one external position transmitting element which is used for parking and/or parking in the surrounding area of the structure and/or the chassis can be arranged.

10. Method for parking in and/or out of a parking space, in particular for parking in and/or out of a campsite and/or for producing and/or maintaining and/or storing a recreational vehicle, in particular a recreational trailer, according to claim 1, wherein a movement of the recreational vehicle is carried out by means of the parking and/or parking operation by means of at least one external position transmitting element.
